(19) United States
(12) Patent Application Publication
(10) Pub. No.: US 2025/0182955 A1
(43) Pub. Date: Jun. 5, 2025

(54) LOW-LEAKAGE OVERMOLDED PLANAR TRANSFORMERS FOR WELDING-TYPE POWER SUPPLIES

(71) Applicant: Illinois Tool Works Inc., Glenview, IL (US)

(72) Inventor: Dennis Sigl, Greenville, WI (US)

(21) Appl. No.: 18/937,702

(22) Filed: Nov. 5, 2024

Related U.S. Application Data
(60) Provisional application No. 63/604,812, filed on Nov. 30, 2023.

(51) Int. Cl. H01F 27/32; B23K 9/10; H01F 27/24

(52) U.S. Cl. CPC H01F 27/32; B23K 9/1043; H01F 27/24

(57) ABSTRACT

Disclosed example high-frequency transformers include: a primary winding; a first secondary winding comprising a first planar conductor and a molded insulator, the first secondary winding being stacked in contact with the primary winding; and a magnetic core that is magnetically coupled to the primary winding and the first secondary winding.

### RELATED APPLICATIONS

The present application claims the benefit of U.S. Provisional Patent Application Ser. No. 63/604,812, filed Nov. 30, 2023, entitled “LOW-LEAKAGE OVERMOLDED PLANAR TRANSFORMERS FOR WELDING-TYPE POWER SUPPLIES.” The entirety of U.S. Provisional Patent Application Ser. No. 63/604,812 is expressly incorporated herein by reference.

### FIELD OF THE DISCLOSURE

The present disclosure relates to welding-type devices and, more particularly, to low-leakage overmolded planar transformers for welding-type power supplies.

### BACKGROUND

Welding-type systems often require a voltage step-down of the primary or input power for a particular welding, cutting, or heating application. Primary, or input power, is typically supplied to the welding, cutting, or heating system at voltages ranging from 110V to 1000V. However, the desired output voltage is typically lower. Generally, transformers, rectifiers, and/or filters are used to convert the input power to usable power for the welding-type application.

A transformer is typically used to reduce or increase the voltage of input power and/or intermediate power to output power that is usable for the particular welding, cutting, or heating application. Transformers are typically made up of primary and secondary windings, or windings, around a metal core. As such, the primary voltage, or input voltage, enters the primary winding and creates a magnetic field that induces voltage in the secondary winding. The secondary winding then yields a voltage that is usable for the welding, cutting, or heating application. Transformers also provide electrical isolation between the input circuit (e.g., the source of input power) and the output circuit (e.g., the welding output).

### SUMMARY

The present disclosure relates to high-frequency transformers and, more particularly, to low-leakage overmolded planar transformers for welding-type power supplies, substantially as illustrated by and described in connection with at least one of the figures, as set forth more completely in the claims.

### BRIEF DESCRIPTION OF THE DRAWINGS

FIG. 1 is an illustration of an example welding-type system in accordance with aspects of this disclosure.

FIG. 2 is a block diagram of an example welding-type power supply including a transformer.

FIG. 3 is a perspective view of an example low-leakage overmolded planar transformer that may be used to implement the transformer of FIG. 2.

FIG. 4 is an exploded view of the example low-leakage overmolded planar transformer of FIG. 3.

FIG. 5 is a side elevation view of the example low-leakage overmolded planar transformer of FIG. 3.

FIG. 6 is a cross-section elevation view of the example low-leakage overmolded planar transformer of FIG. 3.

FIG. 7 is a more detailed view of a portion of the cross-section elevation view of FIG. 6.

FIG. 8 is a side elevation view of one of the secondary windings of the example low-leakage overmolded planar transformer of FIG. 3.

FIG. 9 is a cross-section side elevation view of the secondary winding of the example low-leakage overmolded planar transformer of FIG. 8.

FIG. 10 is a cross-section side end view of the secondary winding of the example low-leakage overmolded planar transformer of FIG. 8.

FIG. 11 is a cross-section elevation view of the secondary winding of the example low-leakage overmolded planar transformer of FIG. 8.

FIG. 12 is a side elevation view of the primary winding of the example low-leakage overmolded planar transformer of FIG. 3.

FIG. 13 is a cross-section side elevation view of the primary winding of the example low-leakage overmolded planar transformer of FIG. 12.

FIG. 14 is an end elevation view of the primary winding of the example low-leakage overmolded planar transformer of FIG. 12.

FIG. 15 is a bottom plan view of the primary winding of the example low-leakage overmolded planar transformer of FIG. 12.

FIG. 16 is a cross-section elevation view of the primary winding of the example low-leakage overmolded planar transformer of FIG. 12.

FIG. 17 is an exploded view of another example primary winding that may be used to implement the overmolded planar transformer of FIG. 3.

FIG. 18 is an exploded view of another example low-leakage overmolded planar transformer that may be used to implement the transformer of FIG. 2.

FIG. 19 is a perspective view of another example primary winding that may be used to implement the overmolded planar transformer of FIG. 3.

The figures are not necessarily to scale. Where appropriate, similar or identical reference numerals are used to refer to similar or identical elements.

### DETAILED DESCRIPTION

High-frequency transformers (e.g., rated to operate between 10 kHz and 500 kHz) are typically used as part of inverter-based power supplies. Leakage inductance in conventional high-frequency transformers (e.g., resulting from primary winding flux that does not link to the secondary winding) may negatively impact the performance of welding-type power supplies. For example, leakage inductance present in conventional high-frequency transformers may reduce the output of the welding-type power supply, may lead to overheating of the primary and/or secondary windings, and/or may be detrimental to transistor switching circuits in the welding-type power supply.

Most transformer coils are constructed by winding magnet wire around a plastic bobbin, or on a mandrel, and insulated with insulating paper or plastic films. The coil consists of a primary winding and one or more secondary windings. To comply with applicable standards, the primary and secondary are required to have adequate creepage distance and clearance between the wires. If the required creepage and/or clearance are not possible, insulation is placed between the coils to extend the path between the coils over the insulation surface. According to standards (e.g., IEC 60974-1), the insulation under the creepage path is also required to be a certain thickness, or Distance Thru Insulation (DTI). As a result, conventional transformers are commonly in clamshell form and/or have paper and/or film insulation between the primary and secondary windings. Alternatively, the winding wires can be constructed to conform to IEC 61558-1, Annex K. Winding the coils of conventional transformers is labor intensive, and the wire is expensive. Conventional coils also tend to be larger than needed, as the wires have a poor space utilization factor.

Disclosed example planar transformers are less labor intensive and less costly to produce, while providing sufficient insulation to meet the required standards for equipment such as welding power supplies and other high power electrical equipment. In particular, disclosed example transformers include stamped conductors, which are insulated using molded insulators. In some examples, primary and/or secondary windings constructed from stamped conductors are insulated using molded insulators, such as by overmolding the conductors with an insulating plastic. The conductors and insulators of the primary and secondary windings are stacked, and a magnetic core is assembled adjacent the windings. Disclosed example transformers are smaller than a wound transformer of similar electrical characteristics due to the compact nature of the stamped conductors, the overmolding process, the configuration of the stamped conductors, and/or the plastic insulators.

Compared to other coating techniques, molding or overmolding is inexpensive, provides a high degree of control over the thickness of the plastic insulator, and provides flexibility with both the material used to mold the insulation and the specific shape of the insulator.

As used herein, the terms “welding-type power supply,” “welding-type power source,” and “welding-type system,” refers to any device capable of, when power is applied thereto, supplying welding, cladding, plasma cutting, induction heating, laser (including laser welding, laser hybrid, and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

As used herein, the term “welding-type power” refers to power suitable for welding, plasma cutting, induction heating, CAC-A and/or hot wire welding/preheating (including laser welding and laser cladding).

As used herein, the term welding-type output means an output signal that is suitable for welding, plasma cutting or induction heating.

As used herein, the term “torch” or “welding-type tool” can include a hand-held or robotic welding torch, gun, or other device used to create the welding arc.

As used herein, the term “welding mode” is the type of process or output used, such as CC, CV, pulse, MIG, TIG, spray, short circuit, etc.

Welding operation, as used herein, includes both actual welds (e.g., resulting in joining, such as welding or brazing) of two or more physical objects, an overlaying, texturing, and/or heat-treating of a physical object, and/or a cut of a physical object) and simulated or virtual welds (e.g., a visualization of a weld without a physical weld occurring).

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code.

The terms “control circuit” and “control circuitry,” as used herein, may include digital and/or analog circuitry, discrete and/or integrated circuitry, microprocessors, digital signal processors (DSPs), and/or other logic circuitry, and/or associated software, hardware, and/or firmware. Control circuits may include memory and a processor to execute instructions stored in memory. Control circuits or control circuitry may be located on one or more circuit boards, that form part or all of a controller, and are used to control a welding process, a device such as a power source or wire feeder, motion, automation, monitoring, air filtration, displays, and/or any other type of welding-related system.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), flash memory, solid state storage, a computer-readable medium, or the like.

Disclosed example high-frequency transformers include: a primary winding; a first secondary winding having a first planar conductor and a molded insulator, the first secondary winding being stacked in contact with the primary winding; and a magnetic core that is magnetically coupled to the primary winding and the first secondary winding.

In some example high-frequency transformers, the primary winding includes a second planar conductor which is overmolded with the insulator, wherein the insulator of the first secondary winding is in contact with the insulator of the primary winding. In some example high-frequency transformers, the second planar conductor includes a plurality of turns.

In some example high-frequency transformers, the insulator is overmolded between the plurality of turns. Some example high-frequency transformers further include a first insulation layer stacked on a first side of the primary winding and a second insulation layer stacked on a second side of the primary winding. In some example high-frequency transformers, at least one of the first insulation layer or the second insulation layer includes channels, in which the plurality of turns are positioned within corresponding ones of the channels such that the channels provide turn-to-turn insulation.

In some example high-frequency transformers, the primary winding comprises a plurality of turns of wire in a planar arrangement. Some example high-frequency transformers further include a second secondary winding having a second stamped conductor which is overmolded with the insulator, in which the second secondary winding is stacked in contact with at least one of the primary winding or the first secondary winding. In some example high-frequency transformers, the second secondary winding is identical to the first secondary winding. In some example high-frequency transformers, the second secondary winding has a reversed orientation relative to the first secondary winding. In some example high-frequency transformers, the second secondary winding comprises a single turn.

In some example high-frequency transformers, the magnetic core includes at least two portions, at least one of the portions having an E-core type. In some example high-frequency transformers, the at least two portions are secured around the primary winding and the first secondary winding. In some example high-frequency transformers, the first secondary winding includes a single turn. In some example high-frequency transformers, the primary winding and the first secondary winding each has a mounting tab, in which the mounting tabs of the primary winding and the first secondary winding are aligned when stacked in the high-frequency transformer.

Disclosed example welding-type power supplies include power conversion circuitry configured to convert input power to welding-type output power, the power conversion circuitry including: an input circuit configured to convert the input power to a first high-frequency signal; a high-frequency transformer configured to convert the first high-frequency signal to a second high-frequency signal, the high-frequency transformer including: a primary winding; a first secondary winding having a first stamped conductor and a molded insulator, the first secondary winding being stacked in contact with the primary winding; and a magnetic core that is magnetically coupled to the primary winding and the first secondary winding; and an output circuit configured to convert the second high-frequency signal to the welding-type output power.

In some example welding-type power supplies, at least one of the input circuit or the output circuit is mounted to a printed circuit board, and the high-frequency transformer is mounted to the printed circuit board via at least one of the primary winding or the first secondary winding. In some example welding-type power supplies, the primary winding and the first secondary winding each has a mounting tab, in which the mounting tabs of the primary winding and the first secondary winding are aligned when stacked in the high-frequency transformer, and the high-frequency transformer is mounted to the printed circuit board or to a chassis of the welding-type power supply via the mounting tabs.

In some example welding-type power supplies, the first secondary winding includes a single turn, and the primary winding includes a plurality of turns. In some example welding-type power supplies, the input circuit includes an inverter stage configured to convert a DC signal to the first high-frequency signal.

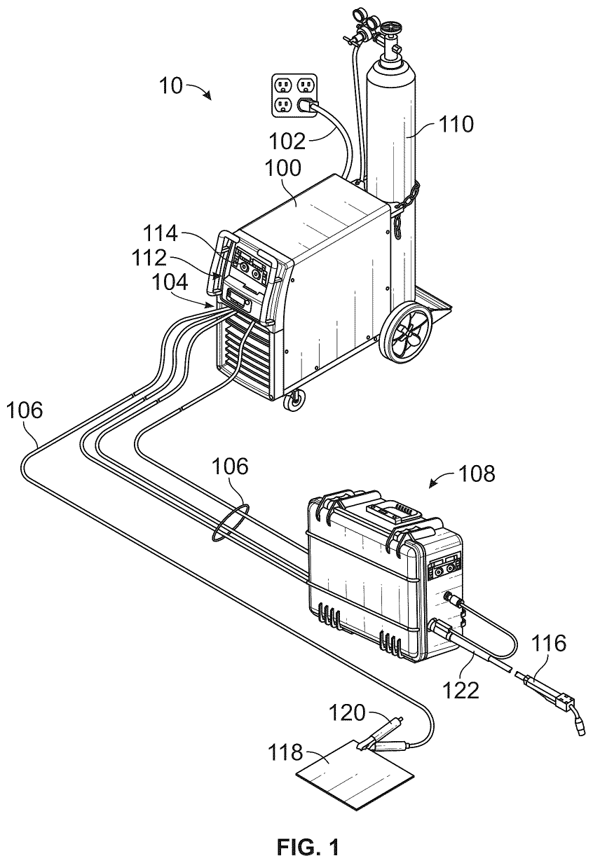

FIG. 1 illustrates an example welding type system 10 including a welding-type power supply 100. A source of power is provided to the welding-type power supply 100 via an AC power cord 102. Typical ranges of AC power may be 115/230 VAC or 208-600 VAC, and may include single-phase or three-phase power. The welding-type power supply 100 generally supplies power for the welding-type system 10. Weld output 104 provides welding output power via one or more weld cables 106 coupled to a welding torch 116 and a workpiece 118 using a clamp 120. The welding-type power supply 100 includes a high-frequency transformer which is used to reduce or increase the voltage of incoming power so that it is usable for the particular welding-type application. The high-frequency transformer includes a primary winding and a secondary winding, or windings, around a magnetic core. Primary voltage, or input voltage enters the primary winding and creates a magnetic field that induces output voltage that is usable for the welding-type application.

Welding-type output power provided by the welding-type power supply 100 may be in the range of 10 Amps to 600 amps or more, and range from substantially 0 volts in a short circuit condition to 44 volts or more into an open welding arc. Modern welding-type power supplies and systems can provide welding-type power for various welding-type processes which may include advanced waveform generation and control that is responsive to dynamic or static conditions at the welding arc.

The illustrated welding type system includes a wire feeder 108 and a gas supply 110. The welding power supply 100 may provide power and control to other equipment such as a wire feeder 108. In the illustrated example, the welding torch 116 is coupled to the wire feeder 108 via coupler 122 in order to supply welding wire, shielding gas from the gas supply 110, and/or welding-type power to the welding torch 116 during operation of the welding-type system 10. In some examples, the welding power supply 100 may couple and/or directly supply welding-type power to the welding torch 116. The wire feeder 108 may require a certain type of power, for example, 24V or 50V for proper operation of the wire feeder 108 control circuits. The power for the wire feeder 108 may be provided by the welding power supply 100 by a wire feeder 108 power supply circuit, or another type power circuit. In addition to power for the wire feeder 108, one or more control signals may also be provided to allow proper operation of the wire feeder 108 and welding power supply 100. These control signals may be analog or digital and may provide control and communication in a bi-directional manner. The power and control signals may be provided to the wire feeder 108 from the welding power source via cable(s) 106.

The illustrated welding power supply 100 has a control panel 112 with various types of control features 112, such as digital displays, control dials or potentiometers, control switches, LED indicators, etc. These control features 112 provide for normal operation and control of the welding system.

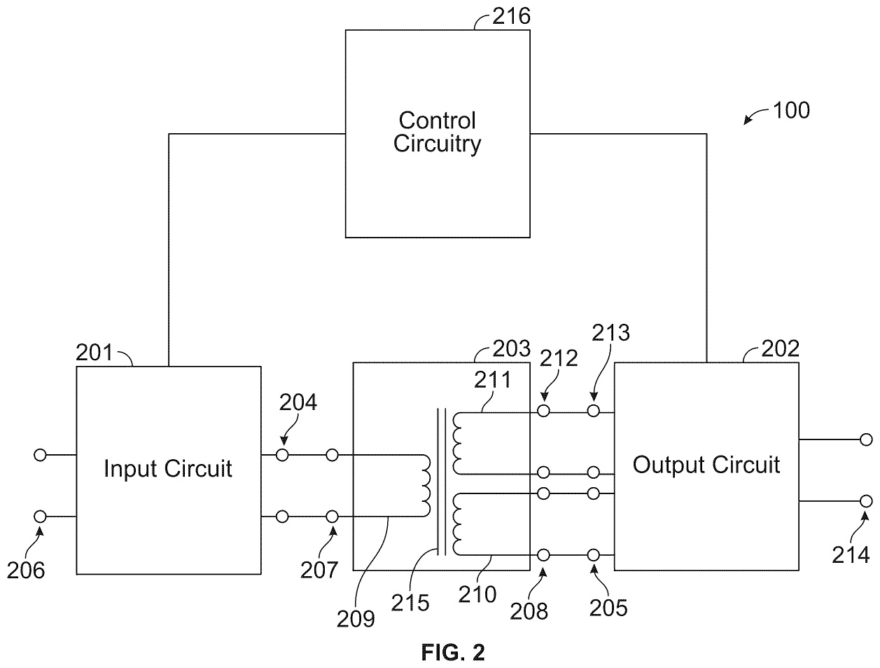

FIG. 2 shows a block diagram of an example welding-type power supply 100. The power supply 100 includes an input circuit 201, an output circuit 202 and a high-frequency transformer 203. Collectively, the input circuit 201, the output circuit 202, and the transformer 203 may be referred to as a switched mode power supply.

The transformer 203 includes a magnetic core 215 (e.g., a ferrite core). The core 215 may be selected to lower leakage inductance, for example based on the amount of turns used. The transformer 203 is connected between an output 204 of input circuit 201 and inputs 205 and 213 of the output circuit 202. The input circuit 201 is configured to receive an input signal from an external source of power at the input 206. Input signal and output signal as used herein include voltage signals, current signals and power signals. The input circuit 201 includes any circuit capable of receiving an input signal from a source of power and providing an output signal usable by a transformer. Input circuits can include as part of their circuitry, microprocessors, analog and digital controllers, switches, other transformers, rectifiers, inverters, converters, choppers, comparators, phased controlled devices, buses, pre-regulators, diodes, inductors, capacitors, or resistors. The output circuit 202 includes any circuit capable of receiving an input signal from a transformer and providing an output signal suitable for a desired purpose, such as welding-type output signal. Output circuits can include microprocessors, analog and digital controllers, switches, other transformers, rectifiers, inverters, converters, choppers, comparators, phased controlled devices, buses, pre-regulators, diodes, inductors, capacitors, or resistors.

In some examples, control circuitry 216 controls the operation of the input circuit 201 and/or the output circuit 202. The control circuitry 216 may include one or more microprocessors and/or other processing and/or control circuitry, memory, storage devices, input/output circuitry, and/or other circuitry.

The input signal received at the input 206 is processed by the various circuitry of the input circuit 201 and the processed signal is provided to the transformer 203 via the output 204. The output signal from the input circuit 201 is received by the transformer 303 via the input 207 and transformed to the outputs 208, 212. The transformer 203 includes a primary winding 209 connected to the output 204 of input circuit 201 and a first secondary winding 210 connected to the input 205 of output circuit 202. The secondary windings 210, 211 is magnetically coupled with the primary winding 209.

As illustrated, the power supply 100 also includes a second secondary winding 211 magnetically coupled with the primary winding 209. The secondary windings 210, 211 may be coupled to a commutator and/or a rectifier in the output circuit 202 to control a polarity of the output 214.

The output signal from the secondary winding 210 is received by the output circuit 202 at input 105. The input signal is processed by the various circuitry of output circuit 202 and the processed signal is provided at the output 214 as a signal suitable for a welding-type application.

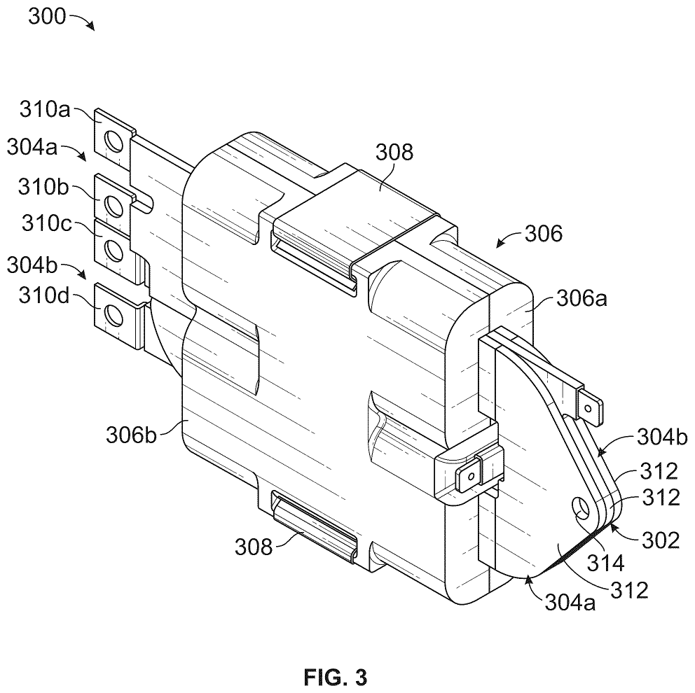

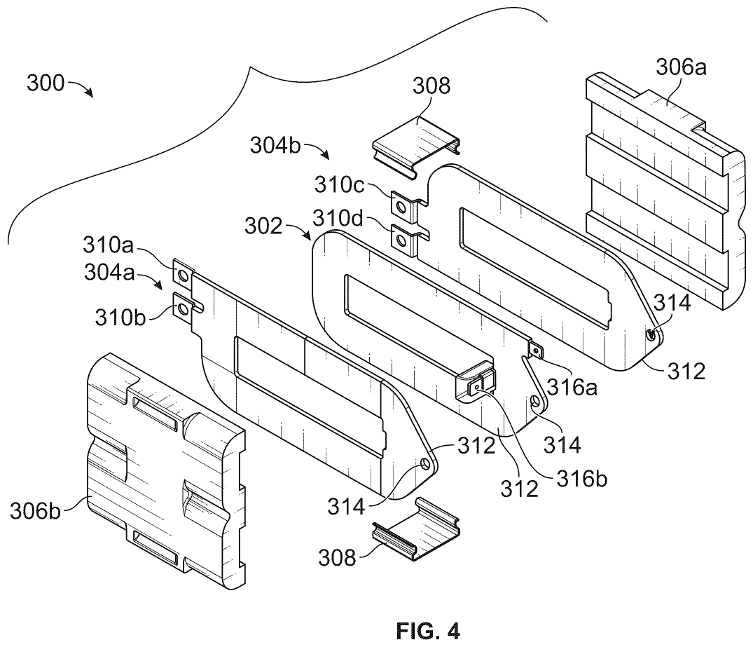

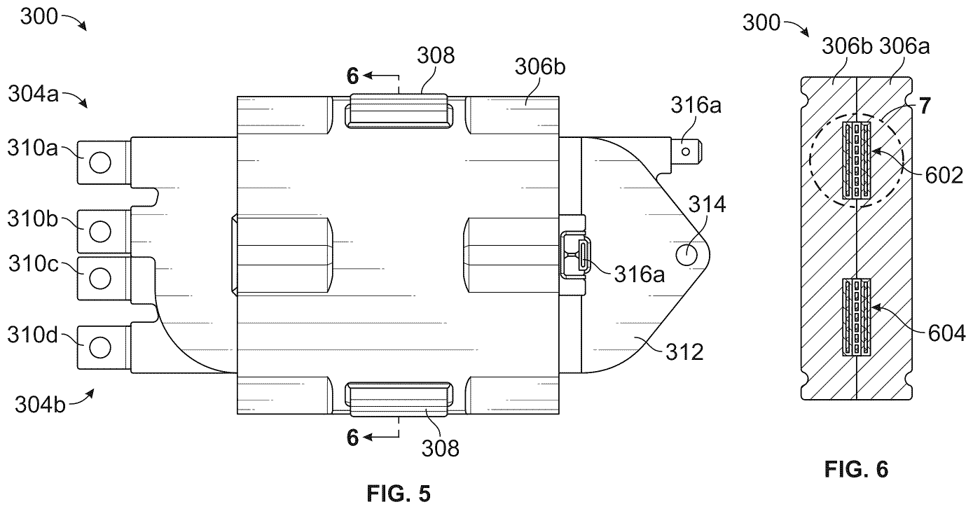

FIG. 3 is a perspective view of an example low-leakage overmolded planar transformer 300 that may be used to implement the transformer 203 of FIG. 2. FIG. 4 is an exploded view of the example low-leakage overmolded planar transformer 300 of FIG. 3. FIG. 5 is a side elevation view of the example low-leakage overmolded planar transformer 300 of FIG. 3. The example transformer 300 of FIGS. 3, 4, and 5 includes a primary winding 302, first and second secondary windings 304a, 304b, and a magnetic core 306.

As described below, the primary winding 302 and the secondary windings 304a, 304b are constructed as planar transformers which are overmolded with insulation and stacked. The magnetic core 306 is magnetically coupled to the primary winding 302 and the secondary windings 304a, 304b and, in the example of FIGS. 3 and 4, holds the stack of windings 302, 304a, 304b together. For example, the magnetic core 306 may be sets of E-type cores 306a, 306b which extend around and through the stack of windings 302, 304a, 304b, and may be clipped together using clips 308 or other fasteners.

The example primary winding 302 and the secondary windings 304a, 304b are both constructed as overmolded (e.g., insert-molded) stamped conductors. For example, the primary winding 302 and the secondary windings 304a, 304b may be individual conductive metal (e.g., aluminum or copper) stampings that are overmolded with insulating plastic to achieve the desired distance-through-insulation (DTI) between the primary winding 302 and each of the secondary windings 304a, 304b, and between each of the windings 302, 304a, 304b and ground (or chassis or other reference). An example lower limit on the insulation thickness is 0.031 inches (0.75 mm).

The primary winding 302 is positioned between and adjacent the secondary windings 304a, 304b. In the example of FIGS. 3 and 4, the secondary windings 304a, 304b are identical, and positioned in reversed orientations. The secondary winding 304a includes secondary terminals 310a, 310b, and the secondary winding 304b includes secondary terminals 310c, 310d. The primary winding 302 similarly includes a first primary terminal 316a and a second primary terminal 316b to couple the primary winding 302 to the input circuit 201 of FIG. 2. The secondary terminals 310a, 310b, 310c, 310d allow physical and electrical connection of the secondary windings 304a, 304b to the output circuit 202 (e.g., on a PCB). Using the secondary terminals 310a-310d, the secondary windings 304a, 304b can be configured as a center-tapped secondary winding or a non-center-tapped winding. By orienting the identical secondary windings 304a, 304b in opposing orientations, the secondary terminals 310a, 310b, 310c, 310d are located in close proximity for ease of configuration and assembly.

Each of the example windings 302, 304a, 304b further includes a respective mounting tab 312. When the windings 302, 304a, 304b are stacked, the mounting tabs 312 are lined up (e.g., respective mounting holes 314 in each of the mounting tabs 312 are aligned). The aligned mounting holes 314 can be used to mount the transformer 300 to another structure via a single screw or other fastener. The terminals 310a-130d at least partially support the weight of the transformer 300, and provide easy access to the secondary terminals 310a-310d to simplify assembly. The center terminals 310b, 310c may be coupled to a bus bar, or leads may be attached to the center terminals 310b, 310c to connect the center tap of the transformer secondary to the negative output terminal of the output circuit 202.

Any of the terminals 310a-310d, 316a-316b may be mounted to another component, such as a PCB or a connector, using screws, rivets, or other fastener. By mounting the 310a-310d to first structure and mounting the tabs 312 to a second structure, the transformer 300 may be completely structurally supported in the power supply 100. The example terminals 316a, 316b may be configured as 0.250 inch faston terminals. The primary conductor 1202 is constructed with a conductor thickness that is sufficient to support the type and/or size of terminals 316a, 316b and/or to support the rated load current within the required operating temperature range and/or transformer cooling system.

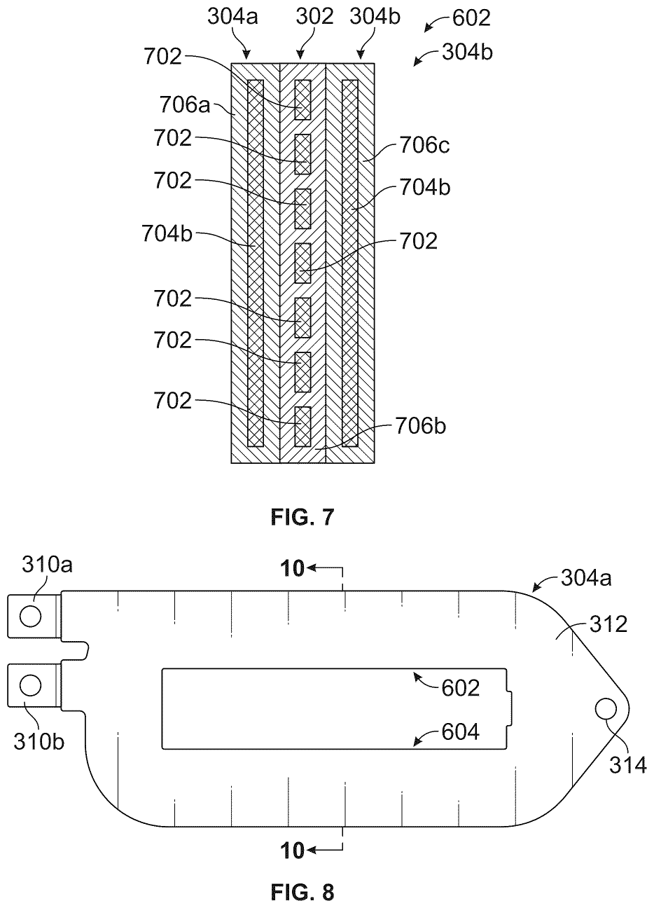

FIG. 6 is a cross-section elevation view of the example low-leakage overmolded planar transformer of FIG. 3 (along line 6-6 of FIG. 5). FIG. 7 is a more detailed view of a portion of the cross-section elevation view of FIG. 6 (detail—7—of FIG. 6).

As shown in FIG. 6, each of the primary winding 302 and the secondary windings 304a, 304b includes a first leg 602 and a second leg 604. The center leg of the magnetic core 306 extends between the first and second legs 602, 604 of the windings 302, 304a, 304b. The center leg of the magnetic core 306 can be ground with a gap to adjust the magnetizing inductance of the primary winding 302. While the example magnetic core 302 includes a single set of two portions 306a, 306b, in other examples the magnetic core 302 is constructed using multiple sets of narrower core portions.

As shown in FIG. 7, each of the primary winding 302 and the secondary windings 304a, 304b includes a respective conductor layer 702, 704a, 704b. One leg of each of the windings 302, 304a, 304b and the conductor layers 702, 704a, 704b is shown in FIG. 7. Each of the conductor layers 702, 704a, 704b is overmolded with an insulator layer 706a, 706b, 706c, which may be a plastic such as Zenite 6130 LCP, Rynite FR-530 GF PET, Petra, Xarec, and/or Radilon GF nylon. The choice of material for the insulator layers 706a-706c may be determined by the desired thicknesses of the insulator layers 706a-706c, operating temperatures, and/or flow distances in the part during overmolding. The insulator layers 706a, 706c of the secondary windings 304a, 304b may be the same as or different from the insulator layer 706b of the primary winding 302.

After overmolding each conductor layer 702, 704a, 704b with the corresponding insulator layer 706a-706c, the windings 302, 304a, 304b are stacked together such that the primary winding 302 is between, and adjacent to each of, the secondary windings 304a, 304b.

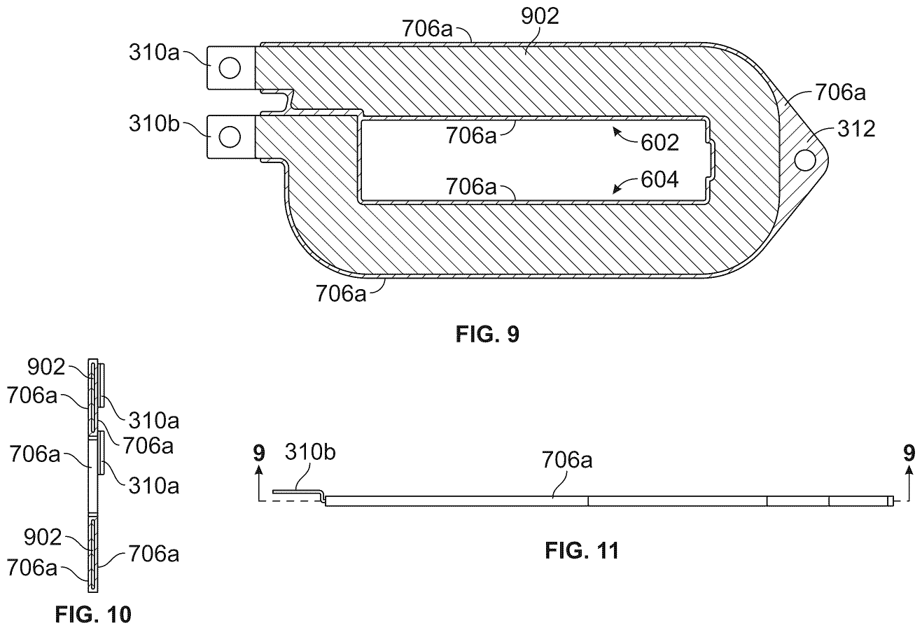

FIG. 8 is a side elevation view of one of the secondary windings 304a of the example low-leakage overmolded planar transformer 300 of FIG. 3. As mentioned above, the secondary winding 304b may be identical to the secondary winding 304a. FIG. 9 is a cross-section side elevation view of the secondary winding 304a of FIG. 8. FIG. 10 is a cross-section side end view of the secondary winding of the example low-leakage overmolded planar transformer of FIG. 8. FIG. 11 is a cross-section elevation view of the secondary winding of the example low-leakage overmolded planar transformer of FIG. 8.

As shown in FIG. 9, the secondary winding 304a includes a stamped conductor 902 forming a single turn. The terminals 310a, 310b are coupled to the ends of the conductor 902 to couple the conductor 902 to the output circuit 202, to one of the terminals 310c, 310d of the secondary winding 304b to form a center-tapped secondary, and/or to both of the terminals 310c, 310d of the secondary winding 304b to form parallel turns.

The insulator 706a is overmolded onto the conductor 902 to provide the desired primary-secondary insulation (alone or in combination with the insulation around the secondary), winding-ground insulation, creepage distance, and/or clearance distance. In some examples, the conductor 902 is overmolded to create a cemented joint. The insulator 706a is also molded to include the mounting tab 312 and the mounting hole 314. In some examples, the mounting hole 314 may be drilled or otherwise removed from the mounting tab 312 after the overmolding and/or after stacking of the windings 302, 304a-304b.

In some examples, the conductor 902 may be overmolded using a retracting pin mold, which uses pins to hold the conductor 902 secure in the middle of a molding cavity. The insulator plastic is injected around the part, and the pins are then retracted. The void(s) in the plastic that are left by the retracting pins are back-filled by the plastic melting. In some other examples, a first side of the insulator 706a is molded, and the conductor 902 is placed into the first side of the insulator 706a. The conductor 902 and first side of the insulator 706a are then put into a mold and overmolded with the remaining plastic.

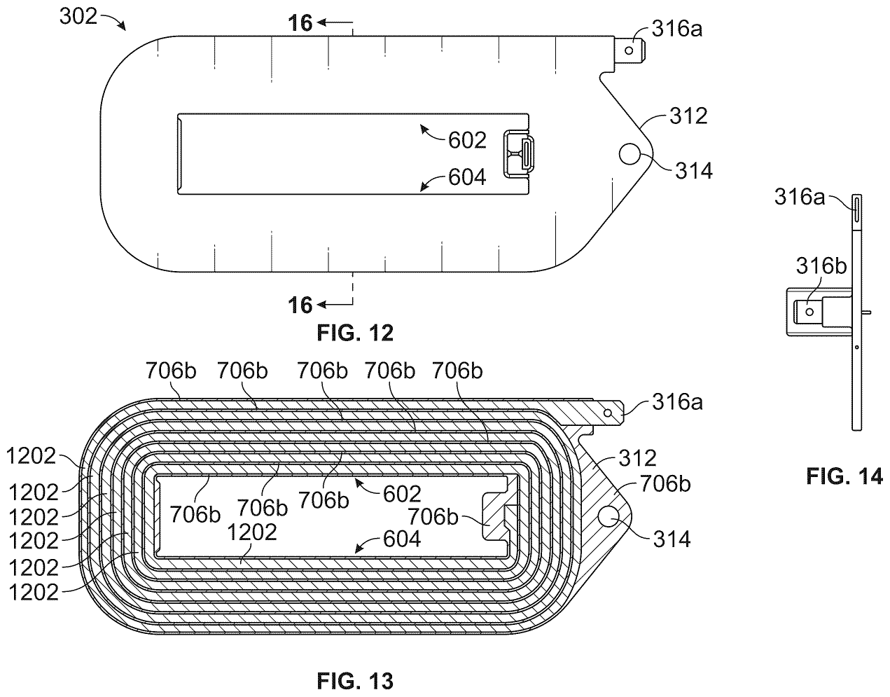

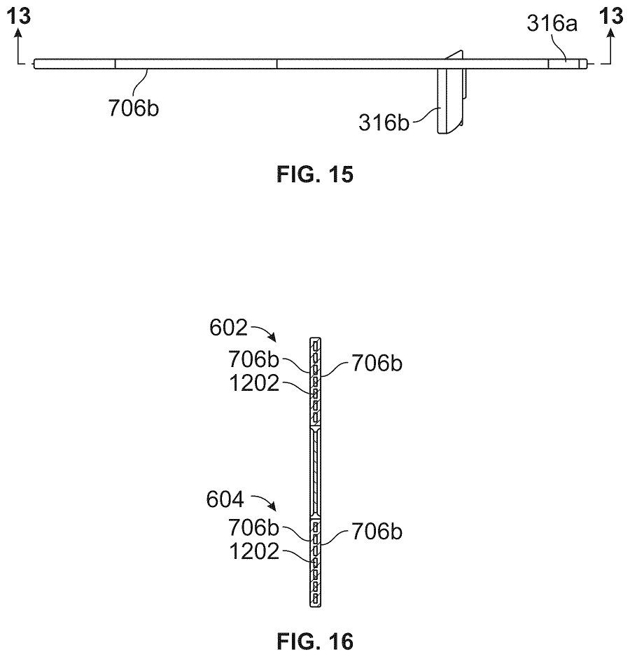

FIG. 12 is a side elevation view of the primary winding 302 of the example low-leakage overmolded planar transformer 300 of FIG. 3. FIG. 13 is a cross-section side elevation view of the primary winding 302 of FIG. 8. FIG. 14 is an end elevation view of the primary winding 302 of FIG. 12. FIG. 15 is a bottom plan view of the primary winding 302 of FIG. 12. FIG. 16 is a cross-section elevation view of the primary winding 302 of FIG. 12.

In contrast with the secondary windings 304a, 304b, the example primary winding 302 includes multiple turns of a stamped conductor 1202.

The conductors 902, 1202 may be constructed with a copper or aluminum stamping of the desired thickness, 3D printing or other additive manufacturing technique, laser cutting, and/or any other manufacturing technique.

The terminals 316a, 316b are coupled to the ends of the conductor 1202 to couple the conductor 1202 to the input circuit 201 of FIG. 1, to a terminal of another primary winding, and/or to both terminals of another winding to form parallel turns of a transformer primary. The terminal 316a extends in plane with the turns. The terminal 316b extends out-of-plane with the turns of the winding 302. While the terminal 316b is positioned at an end of the magnetic core 306, in other examples the terminal 316b may be positioned between laterally adjacent sections of the magnetic core 306 and/or may extend an opposite direction than the illustrated direction. The terminal 316b may be molded with plastic insulator to provide the required creepage and clearance to the magnetic core 306.

The insulator 706b is overmolded onto the conductor 1202 to provide the desired primary-secondary insulation (alone or in combination with the insulation around the secondary), winding-ground insulation, creepage distance, and/or clearance distance. In some examples, the conductor 1202 is overmolded to create a cemented joint. The insulator 706b is also molded to include the mounting tab 312 and the mounting hole 314.

In some examples, the conductor 1202 may be overmolded using a retracting pin mold, which uses pins to hold the conductor 1202 secure in the middle of a molding cavity. However, due to the multiple turns, uses of the retracting pin mold may further involve creating a mold support to support the conductor 1202 during molding. The mold support is placed into the retracting pin mold with the conductor 1202 attached, and the insulator 706b is molded over the conductor 1202 and the mold support. In some examples, the mold support may be removed after a partial overmolding, following by overmolding of the remaining insulator 706b.

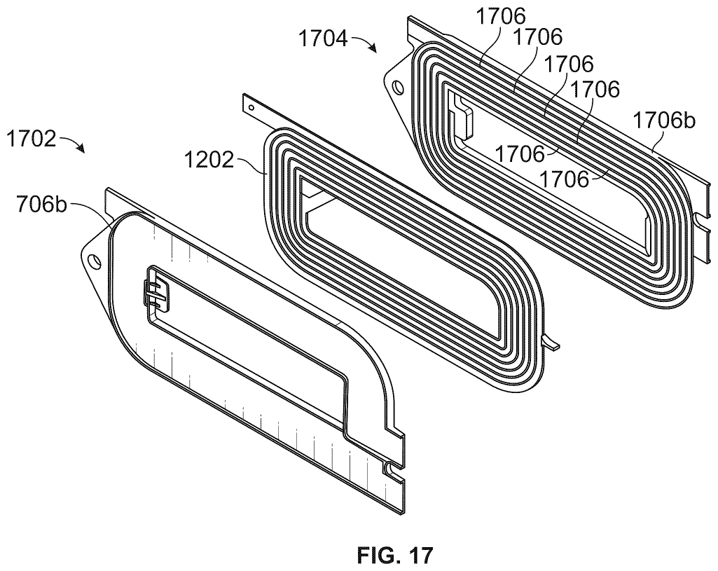

FIG. 17 is an exploded view of another example primary winding 302 that may be used to implement the overmolded planar transformer 300 of FIG. 3. While the secondary windings 304a, 304b may be overmolded as disclosed above, the primary winding 302 may be more easily manufactured by molding first and second pieces 1702, 1704 of the insulator 706b. The first and second pieces 1702, 1704 are molded to include channels 1706, into which the conductor 1202 is placed. While seated in the channels 1706, the turns of the conductor 1202 are insulated by the sides of the channels 1706. After placing the first and second pieces 1702, 1704 over the conductor 1202, the first and second pieces 1702, 1704 may be overmolded with a small amount of the insulator 706b (or another insulator) at the seams between the first and second pieces 1702, 1704 to bond the insulator 706b and create a cemented joint.

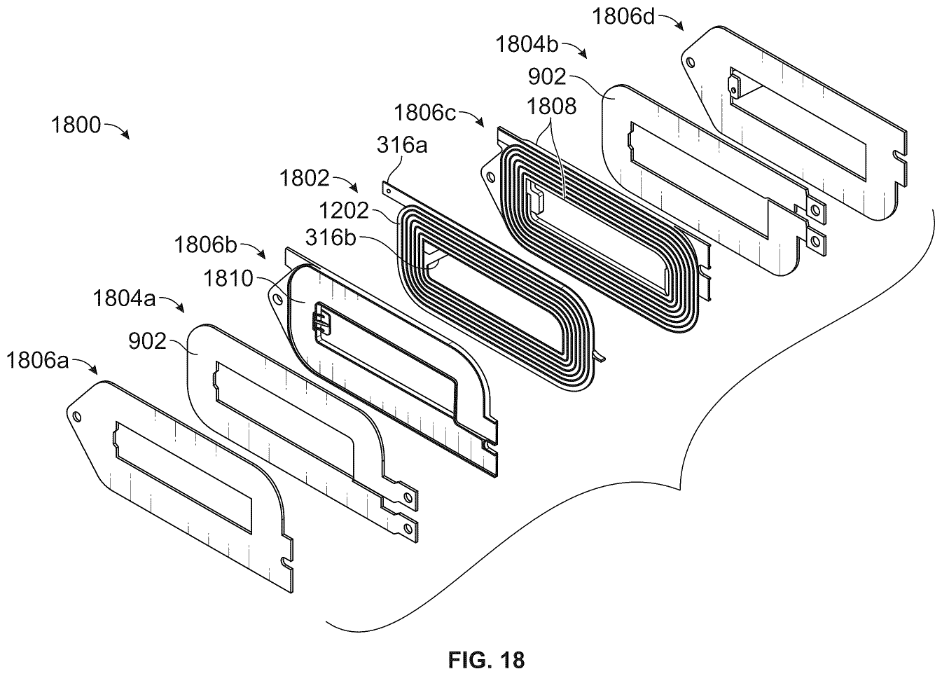

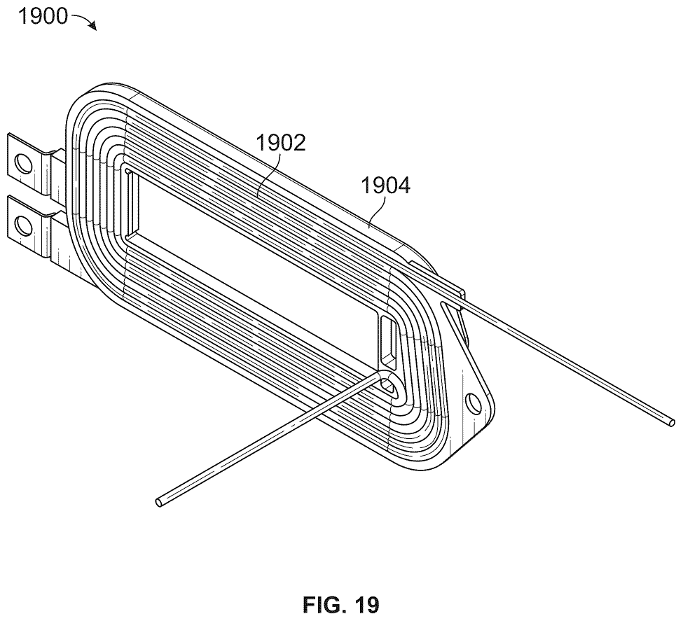

FIG. 18 is an exploded view of another example low-leakage overmolded planar transformer 1800 that may be used to implement the transformer 203 of FIG. 2. The example transformer 1800 includes a single primary winding 1802 and first and second secondary windings 1804a, 1804b. The primary winding 1802 may include the stamped conductor 1202 of FIG. 12 having multiple turns. Similarly, the secondary windings 1804a, 1804b may each include the stamped conductor 902. The transformer 1800 further includes a magnetic core (not shown in FIG. 18), which may be the same as the magnetic core 306 disclosed above or a different type or size of magnetic core.

In the example of FIG. 18, the conductors 902, 1202 of the windings 1802, 1804a, 1804b are insulated using insulation layers 1806a-1806d of a molded insulator. The molded insulator may be any of the example insulators disclosed above with reference to the insulators 706a-706c, or a different material. The example insulation layers 1806b, 1806c include primary channels 1808 on respective sides, into which the conductor 1202 is placed. The insulation layers 1806b, 1806c each include secondary channels 1810 on respective sides opposing the primary channels 1808. The conductors 902 are placed into the secondary channels 1810, such that the insulation layers 1806b, 1806c provide primary-secondary insulation between the windings 302, 304a, 304b.

The outermost insulation layers 1806a, 1806d are placed over the conductors 902 to insulate the conductors 902. The insulation layers 1806a-1806d form a molded, insulated planar transformer assembly. The assembly may be further overmolded to bond the seams between the insulation layers 1806a-1806d and/or the assembly may be wrapped in an insulator, such as a PET film tape or other wrapped insulation, to cover creepage paths from the conductor 902 to the magnetic core 306.

In other examples, to reduce the number of molds used to form the transformer 1800, the conductors 902 may be wrapped in a PET film tape or other wrapped insulation instead of using outer layers 1802a, 1802d of the insulator. Additionally or alternatively, the inner layers 1802b, 1802c may be molded to be identical, such as by adding or removing single-sided insulation features for the terminals 316a, 316b of the primary winding 1802.

FIG. 19 is a perspective view of another example primary winding 1900 that may be used to implement the overmolded planar transformer 300 of FIG. 3. The primary winding 1900 may be used in place of the primary winding 302 of FIG. 3, in conjunction with the overmolded secondary windings 304a, 304b.

Instead of using a stamped conductor, the example primary winding 1900 includes a coil of magnet wire 1902 (e.g., copper or aluminum wire, coated with a thin layer of insulation). The magnet wire 1902 includes a desired number of turns, and is seated or nested within a molded insulator 1904. The coil of magnet wire 1902 avoids expensive stamping tools to construct the primary winding 1900.

The insulator 1904 may be a molded insulator, similar to the insulation layers 1802b, 1802c of FIG. 18. In some examples, the opposite side of the insulator 1904 may include a channel to seat the conductor 902 of one of the secondary windings 304a, 304b. In such examples, the transformer may be assembled using two identical or symmetric insulators 1904 to reduce a number of molds involved in constructing the transformer assembly. The wire 1902 may be used in place of the stamped conductor 1202 and the insulator layer 1904 may be used in place of each of the insulator layers 1802b, 1802c to form a similar planar transformer assembly as in FIG. 18.

The present devices and/or methods may be realized in hardware, software, or a combination of hardware and software. The present methods and/or systems may be realized in a centralized fashion in at least one computing system, processors, and/or other logic circuits, or in a distributed fashion where different elements are spread across several interconnected computing systems, processors, and/or other logic circuits. Any kind of computing system or other apparatus adapted for carrying out the methods described herein is suited. A typical combination of hardware and software may be a processing system integrated into a welding power supply with a program or other code that, when being loaded and executed, controls the welding power supply such that it carries out the methods described herein. Another typical implementation may comprise an application specific integrated circuit or chip such as field programmable gate arrays (FPGAs), a programmable logic device (PLD) or complex programmable logic device (CPLD), and/or a system-on-a-chip (SoC). Some implementations may comprise a non-transitory machine-readable (e.g., computer readable) medium (e.g., FLASH memory, optical disk, magnetic storage disk, or the like) having stored thereon one or more lines of code executable by a machine, thereby causing the machine to perform processes as described herein. As used herein, the term “non-transitory machine readable medium” is defined to include all types of machine readable storage media and to exclude propagating signals.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A high-frequency transformer, comprising:
a primary winding;
a first secondary winding comprising a first planar conductor and a molded insulator, the first secondary winding being stacked in contact with the primary winding; and
a magnetic core that is magnetically coupled to the primary winding and the first secondary winding.

2. The high-frequency transformer as defined in claim 1, wherein the primary winding comprises a second planar conductor which is overmolded with the insulator, wherein the insulator of the first secondary winding is in contact with the insulator of the primary winding.

3. The high-frequency transformer as defined in claim 2, wherein the second planar conductor comprises a plurality of turns.

4. The high-frequency transformer as defined in claim 3, wherein the insulator is overmolded between the plurality of turns.

5. The high-frequency transformer as defined in claim 3, further comprising a first insulation layer stacked on a first side of the primary winding and a second insulation layer stacked on a second side of the primary winding.

6. The high-frequency transformer as defined in claim 5, wherein at least one of the first insulation layer or the second insulation layer comprises channels, the plurality of turns being positioned within corresponding ones of the channels such that the channels provide turn-to-turn insulation.

7. The high-frequency transformer as defined in claim 1, wherein the primary winding comprises a plurality of turns of wire in a planar arrangement.

8. The high-frequency transformer as defined in claim 1, further comprising a second secondary winding comprising a second stamped conductor which is overmolded with the insulator, the second secondary winding being stacked in contact with at least one of the primary winding or the first secondary winding.

9. The high-frequency transformer as defined in claim 8, wherein the second secondary winding is identical to the first secondary winding.

10. The high-frequency transformer as defined in claim 9, wherein the second secondary winding has a reversed orientation relative to the first secondary winding.

11. The high-frequency transformer as defined in claim 8, wherein the second secondary winding comprises a single turn.

12. The high-frequency transformer as defined in claim 1, wherein the magnetic core comprises at least two portions, at least one of the portions having an E-core type.

13. The high-frequency transformer as defined in claim 12, wherein the at least two portions are secured around the primary winding and the first secondary winding.

14. The high-frequency transformer as defined in claim 1, wherein the first secondary winding comprises a single turn.

15. The high-frequency transformer as defined in claim 1, wherein the primary winding and the first secondary winding each has a mounting tab, the mounting tabs of the primary winding and the first secondary winding being aligned when stacked in the high-frequency transformer.

16. A welding-type power supply, comprising power conversion circuitry configured to convert input power to welding-type output power, the power conversion circuitry comprising:
an input circuit configured to convert the input power to a first high-frequency signal;
a high-frequency transformer configured to convert the first high-frequency signal to a second high-frequency signal, the high-frequency transformer comprising:
a primary winding;
a first secondary winding comprising a first stamped conductor and a molded insulator, the first secondary winding being stacked in contact with the primary winding; and
a magnetic core that is magnetically coupled to the primary winding and the first secondary winding; and
an output circuit configured to convert the second high-frequency signal to the welding-type output power.

17. The welding-type power supply as defined in claim 16, wherein at least one of the input circuit or the output circuit is mounted to a printed circuit board, and the high-frequency transformer is mounted to the printed circuit board via at least one of the primary winding or the first secondary winding.

18. The welding-type power supply as defined in claim 17, wherein the primary winding and the first secondary winding each has a mounting tab, the mounting tabs of the primary winding and the first secondary winding being aligned when stacked in the high-frequency transformer, and the high-frequency transformer is mounted to the printed circuit board or to a chassis of the welding-type power supply via the mounting tabs.

19. The welding-type power supply as defined in claim 16, wherein the first secondary winding comprises a single turn, and the primary winding comprises a plurality of turns.

20. The welding-type power supply as defined in claim 16, wherein the input circuit comprises an inverter stage configured to convert a DC signal to the first high-frequency signal.
